(19) United States
(12) Patent Application Publication
(10) Pub. No.: US 2010/0275354 A1
(43) Pub. Date: Nov. 4, 2010

(54) Whisper Flush Toilet Seat/Cover

(76) Inventor: Joseph McCarthy, Lester, PA (US)

Correspondence Address: Joseph S. McCathy, P.O. Box 272, Essington, PA, 19029, US

(21) Appl. No.: 12/400,229

(22) Filed: Apr. 30, 2009

(51) Int. Cl. F16J 15/10; F16J 15/02; A47K 13/00

(52) U.S. Cl. 4/237; 277/312

(57) ABSTRACT

The invention provides for a toilet seat that significantly reduces flush noise. The toilet seat is designed with dosed cell rubber gaskets that help keep sound from getting out of the toilet bowl, but allows equalizing air pressure into the toilet bowl to ensure proper flushing as a totally sealed toilet bowl will not flush properly, The flexible rubber gaskets are attached to the bottom of the toilet lid and the bottom of the seat to seal lid to seat and seat to bowl when the lid and seat are closed. The rubber gasket employs a saw-toothed lip to help assist air flow into the toilet bowl by making the seal less rigid. The toilet seat is designed to fit standard round or oval U.S. toilets, Sound reduction is significant and is between 10 and 20 decibels or approximately a 40% noise reduction based on sound testing.

### SPECIFICATION

### Disclosure

### Detailed Description of the Invention

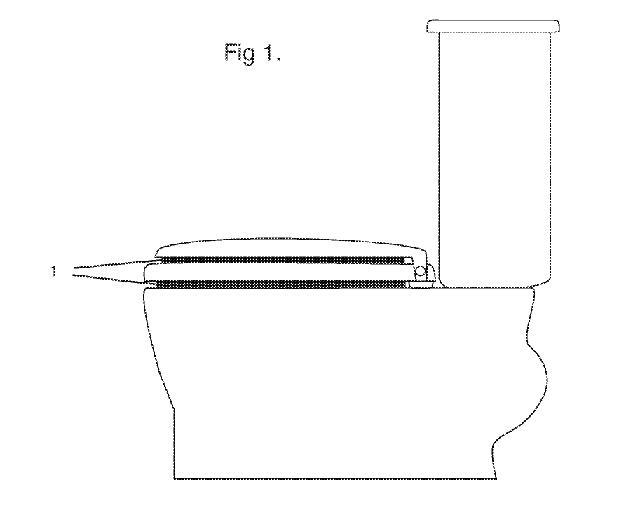

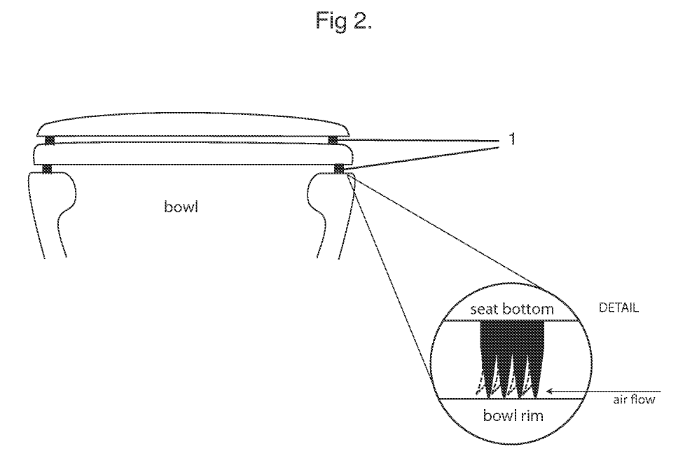

The invention provides for a toilet seat that significantly reduces flush noise, The toilet seat is designed with closed cell rubber gaskets (not foam rubber that help keep sound from getting out of the toilet bowl, but allows equalizing air pressure into the toilet bowl to ensure proper flushing. Allowing air into to toilet bowl is necessary to equalize the air presser, as a totally sealed toilet bowl will not flush properly. The flexible rubber gaskets are attached to the bottom of the toilet lid and the bottom of the seat to seal the gap between the lid and seat and the seat too the bowl (FIG. 1). When the lid and seat are closed a sound trapping seal is made. The rubber gasket employs a saw-toothed lip to help assist airflow into the toilet bowl by making the seal less rigid (FIG. 2). The toilet seat is designed to fit standard round or oval U.S. toilets. Sound reduction is significant and is between 10 and 20 decibels or approximately a 40% noise reduction based on sound testing,

### DETAILED DESCRIPTION/DRAWINGS

FIG. 1

Rubber gasket (shown solid black and labeled is attached to the bottom of the toilet lid and seat.

FIG. 2 (cross-section)

The rubber gaskets run all around the toilet lid and seat. (shown solid black and labeled 1).

FIG. 2 detail.

Shows rubber gasket profile in solid black with detail of saw-toothed sealing lip.

What I claim as my invention is:

1. Toilet seat with rubber gasket that helps keep sound from getting out of the toilet bowl, but allows for equalizing aft pressure into the toilet bowl.

2. Implementation of a rubber gasket around toilet seat and lid for the purpose of sound reduction. Resulting in a 10 to 20 decibels reduction is sound.

3. Implementation of a saw toothed profile on the rubber seal for the purpose of creating a flexible seal (soft seal) to allow some air flow into the toilet bowl.
